(19) United States
(12) Patent Application Publication
(10) Pub. No.: US 2026/0368531 A1
(43) Pub. Date: Nov. 19, 2026

(54) Systems and Methods for Fine-Tuning Generative Models for Detecting the Relevance of Content Items

(71) Applicant: Google LLC, Mountain View, CA (US)

(72) Inventors: Zhaoyi Meng, Los Altos, CA (US); Yancheng Li, Albertson, NY (US); Tian Xia, Jersey City, NJ (US); Hongliang Fei, Sunnyvale, CA (US); Francois Walter Michel Belletti, Bellevue, WA (US); Jieru Mei, Sunnyvale, CA (US); Charles Baxter Boyd, Santa Clara, CA (US)

(21) Appl. No.: 19/209,427

(22) Filed: May 15, 2025

(51) Int. Cl. G06N 3/0895

(52) U.S. Cl. CPC G06N 3/0895

(57) ABSTRACT

Systems and methods for fine-tuning a generative model for detecting the relevance of content items are provided. The method includes receiving, by a computing system, a website identifier associated with a web resource; extracting, by the computing system, a plurality of assets from the web resource based on the website identifier; generating, by a first machine-learning model operating on the computing system, a summarization of the web resource based on the plurality of assets; processing, by a second machine-learning model operating on the computing system, the summarization of the web resource to generate a content item; and processing, by a large language model (LLM) operating on the computing system, the content item to generate a binary content score based on the summarization of the web resource.

### FIELD

The present disclosure relates generally to systems and methods for fine-tuning a generative model for detecting the relevance of content items.

### BACKGROUND

Generative models are used to create content items for entities by drawing from their digital presence. While this approach improves efficiency in content production, the resulting content often lacks proper contextual alignment with the entity's identity or message. A substantial portion of the generated content items are irrelevant or misrepresentative.

The current method for addressing this issue primarily relies on human reviewers to assess the relevance of each generated item. While effective, this manual classification process is labor-intensive, costly, and difficult to scale. These limitations make existing solutions unsuitable for widespread deployment.

Thus, there is a need for a model that can automatically evaluate and classify content items for relevance to the originating entity, without requiring human input. However, building such a model presents substantial technical challenges. Models with the necessary multimodal understanding are typically large and computationally demanding. Also, training such models is resource-intensive and often cost-prohibitive. Furthermore, deploying these models in production introduces additional burdens, as each inference may consume significant computational resources, making them unsuitable for high-throughput environments.

Accordingly, improved systems and methods for fine-tuning a generative model for detecting the relevance of content items are desired in the art. In particular, generative models for detecting the relevance of content items which provide a reduction in the computational resources needed during inference would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a method for fine-tuning a generative model for detecting the relevance of content items is provided. The method includes receiving, by a computing system, a website identifier associated with a web resource; extracting, by the computing system, a plurality of assets from the web resource based on the website identifier; generating, by a first machine-learning model operating on the computing system, a summarization of the web resource based on the plurality of assets; processing, by a second machine-learning model operating on the computing system, the summarization of the web resource to generate a content item; and processing, by a large language model (LLM) operating on the computing system, the content item to generate a binary content score based on the summarization of the web resource.

In accordance with another embodiment, a system for fine-tuning a generative model for detecting the relevance of content items is provided. The system includes one or more processors; and one or more transitory or non-transitory computer-readable media storing instructions that are executable to cause the one or more processors to perform operations. The operations include receiving a website identifier associated with a web resource; extracting a plurality of assets from the web resource based on the website identifier; generating, by a first machine-learning model, a summarization of the web resource based on the plurality of asset processing, by a second machine-learning model, the summarization of the web resource to generate a content item; and processing, by a large language model (LLM), the content item to generate a binary content score based on the summarization of the web resource, wherein the LLM deploys a logit masking technique to generate the binary content score, wherein the logit masking technique comprises restricting an output space of the LLM to a predefined set of tokens corresponding to binary classes of the binary content score.

In accordance with a third embodiment, a method for fine-tuning a generative model for detecting the relevance of content items is provided. The method includes receiving, by a computing system, a training set comprised of exemplary content items correlated to at least one class associated with a binary content score, wherein the training set further comprises one or more performance metrics associated with each of the exemplary content items, wherein the one or more performance metrics are indicative of the exemplary content items' relevance to the binary class; fine-tuning, by the computing system, a Large Language Model (LLM) using the training set, wherein fine-tuning the LLM comprises optimizing a set of parameters of the LLM based at least in part on the performance metrics; and restricting, by the computing system, an output space of the LLM to a predefined set of tokens corresponding to binary classes of the binary content score

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a block diagram of an exemplary generative model for detecting the relevance of content items in accordance with embodiments of the present disclosure;

FIG. 2 is a block diagram of an exemplary logit masking technique associated with a generative model for detecting the relevance of content items in accordance with embodiments of the present disclosure; and

FIG. 3 is a flow diagram of a method for fine-tuning a generative model for detecting the relevance of content items in accordance with embodiments of the present disclosure.

### DETAILED DESCRIPTION

The present disclosure is directed to systems and methods for fine-tuning a generative model for detecting the relevance of content items. Generative models are used to create content items for entities by drawing from their digital presence. While this approach improves efficiency in content production, the resulting content often lacks proper contextual alignment with the entity's identity or message. A substantial portion of the generated content items are irrelevant or misrepresentative.

The current method for addressing this issue primarily relies on human reviewers to assess the relevance of each generated item. While effective, this manual classification process is labor-intensive, costly, and difficult to scale. These limitations make existing solutions unsuitable for widespread deployment.

There is a need for a model that can automatically evaluate and classify content items for relevance to the originating entity, without requiring human input. However, building such a model presents substantial technical challenges. Models with the necessary multimodal understanding are typically large and computationally demanding. Also, training such models is resource-intensive and often cost-prohibitive. Furthermore, deploying these models in production introduces additional burdens, as each inference may consume significant computational resources, making them unsuitable for high-throughput environments.

The present disclosure describes a technical advancement over existing content relevance evaluation methods through the use of a fine-tuned large language model (LLM). This model classifies content items based on a comparison of a summarization of a web resource to the associated content item. The output of the LLM is a binary content score that labels the item as either relevant or irrelevant. This eliminates the need for costly manual review or the use of large, general-purpose models for simple classification tasks.

The improvement of the LLM lies in its implementation as a small language model (SLM) or a lightweight large language model (LLM) tailored for binary classification. During inference, the LLM uses logit masking to restrict its output to a predefined set of tokens representing binary labels. This design choice significantly reduces computational overhead by avoiding unnecessary token generation, thereby improving inference speed and efficiency. LLMs often employ multiple sampling steps to estimate probabilities, but in this case, the binary nature of the task allows for a major simplification. By evaluating only the logits for the first token position, specifically comparing just the two tokens representing “relevant” and “irrelevant,” the LLM eliminates the need for any sampling or further token generation.

Additionally, the logit masking technique may be useful for reducing the risk of hallucinations in embodiments where both content item generation and content classification rely on the same summarization. By constraining the output space through logit masking, the model effectively limits the potential for hallucinations by preventing the generation of ungrounded or unrelated tokens that do not directly reflect the summarization. This design choice improves computational efficiency by reducing unnecessary token generation and ensures tighter semantic alignment between the summarization, content item, and final scoring. Accordingly, the LLM represents an improvement over existing techniques by enabling cost-effective relevance classification of content items at scale.

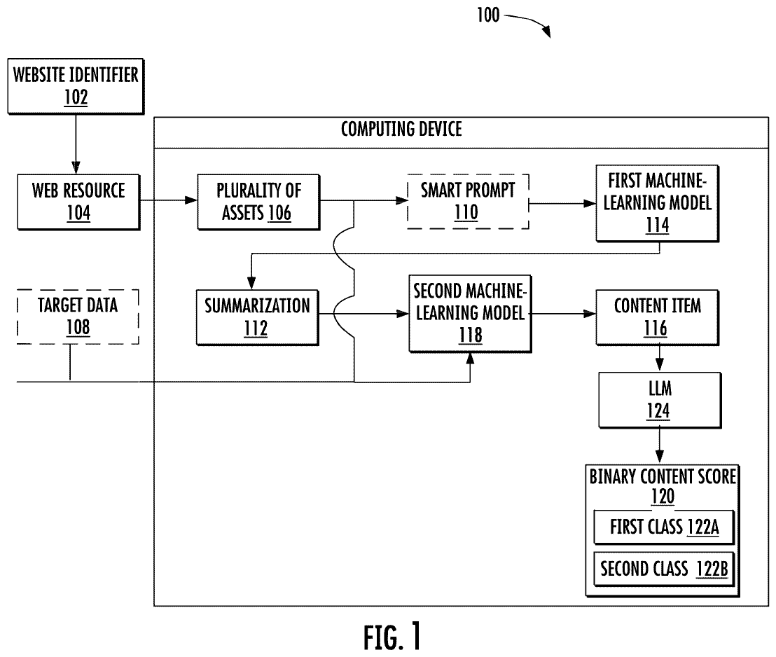

Referring now to the drawings, FIG. 1 is a block diagram of an exemplary system for fine-tuning a generative model for detecting the relevance of content items.

The operations include receiving a website identifier 102, which uniquely identifies or locates a web resource 104. This identifier can be a URL, IP address, domain name, or similar data, used by the computing system to retrieve or access the web resource. The website identifier 102 may be provided by a user, system, or external service, and used to start a data extraction process. A web resource 104 refers to any content or data retrievable from the web location identified by the website identifier 102, including websites, web pages, or web applications. It can consist of text, images, multimedia, scripts, metadata, or other digital components that define the structure and content of the source.

With continued reference to FIG. 1, the operations include extracting, by the computing system, a plurality of assets 106 from the web resource 104 based on the website identifier 102. As used in the current disclosure, an asset refers to individual content components that are presented within or otherwise accessible through the web resource 104. In various embodiments, the plurality of assets 106 may include textual data (e.g., headers, body text, menus, metadata, product/service descriptions, and the like), graphical data (e.g., static images, logos, or icons), and audiovisual media (e.g., embedded videos, animations, or interactive elements). The assets may be structured or unstructured, and may be extracted in whole or in part. The plurality of assets 106 may be stored locally, cached temporarily, or processed in real-time to enable subsequent operations.

System 100 may further extract the plurality of assets 106 in a manner that is directed toward or filtered by a target data 108. As used in the current disclosure, the target data 108 refers to any descriptor, keyword, or structured input that identifies a product, service, brand, or subject matter represented within the web resource 104. The target data 108 may act as a reference for asset extraction. For example, where a website includes multiple product categories or service offerings, the target data 108 may specify a particular product line, brand, or service of interest. System 100 may use the target data 108 to perform relevance scoring, keyword matching, or heuristic filtering on the extracted content. Target data 108 may be derived or received from a variety of sources, including but not limited to user input, pre-defined campaign objectives, automated categorization based on the entity or client, or system-level configurations.

With continued reference to FIG. 1, the operations may include generating a smart prompt 110 based on the target data 108 and the plurality of assets 106. A smart prompt 110, as used in the present disclosure, refers to a contextually enriched input query formulated for consumption by a machine learning model to elicit a structured and relevant output. The smart prompt 110 may be used to capture context from the web resource 104, stylistic cues, and content structure in a format that can guide the model toward producing a desired output that accurately reflects the identity and offerings of the associated web resource 104.

The smart prompt 110 may be constructed using either a zero-shot or a few-shot (multi-shot) prompting method. The few-shot prompt may include one or more exemplary input-output pairs to demonstrate the format, tone, or logic expected from the model's response. These examples may be selected or generated system 100 based on the similarity of the current target data 108 to previously processed data.

The selection process for the multi-shot prompt may include identifying exemplary input-output pairs that are contextually similar to the current target data 108 and the plurality of assets 106 extracted from the web resource 104. System 100 may compare the semantic features of the current website (e.g., industry, product category, tone, or structure) to a repository of previously generated summaries. Based on this similarity analysis, system 100 may select examples that best reflect the expected format and intent of the desired output, ensuring that the prompt guides the model toward producing a coherent and relevant response.

With continued reference to FIG. 1, the operations include generating, by a first machine-learning model 114, a summarization 112 of the web resource 104 based on a plurality of assets 106. The summarization 112 refers to a condensed representation of the web resource's 104 content. In some embodiments, the summarization 112 may be purely textual, including descriptions of products, services, branding, and tone of the web resource 104. For example, a bakery's summarization might emphasize artisanal breads, locally sourced ingredients, and custom cake options, while reflecting the tone and style of the source content. In other embodiments, the summarization 112 may be multi-modal, incorporating both text and representative images, color palettes, logos, audio, video, or product visuals.

The first machine-learning model 114 may utilize transformer-based architectures, such as large language models (LLMs) or multi-modal generative models. The first machine-learning model 114 may leverage attention-based mechanisms or embedding fusion layers to produce richer, context-aware outputs to process the plurality of assets 106 and the smart prompt 108.

To initiate the summarization process, the first machine-learning model 114 may tokenize and encode the assets 106, generating structured embeddings that capture the semantic content of the web resource. These embeddings may be processed alongside the smart prompt 110, which provides context to guide the model's output toward the desired summarization objectives. During this process, the model may leverage attention mechanisms to prioritize the most relevant parts of the input while down-weighting less critical or redundant information. Additionally, the model may adjust the summarization 112 based on user preferences or target data 108.

With continued reference to FIG. 1, the operations of system 100 include processing, by a second machine-learning model 118, the summarization 112 of the web resource 104 to generate a content item 116. As used herein, a content item 116 refers to a media output that is representative of at least a portion of the summarization 112. This can include text, images, videos, audio clips, infographics, or a multimodal combination of any of the above.

The second machine-learning model 118 may be configured to interpret the summarization 112 as a semantic guide, transforming it into a content item 116 using architectures such as diffusion models, generative adversarial networks (GANs), or multimodal transformers. For text-based inputs, the model may encode the summarization 112 into latent vectors that capture the intent and themes of the original content, serving as structured instructions for the generation process. In embodiments where the summarization 112 is multimodal, the second machine-learning model 118 may process additional inputs such as representative images, color schemes, or audio clips referenced in the summarization.

In some cases, the second model may include a text-to-image (T2I) model, which is designed to generate images from textual descriptions. The T2I model can utilize various natural language processing and image generation techniques to accurately reflect the tone, style, and context provided by the original web resource.

With continued reference to FIG. 1, the operations include processing, by a large language model (LLM) 124 operating on the computing system, the content item 116 to generate a binary content score 120 based on the summarization 112 of the web resource 104. As used in the current disclosure, a binary content score 120 is a classification output produced by the LLM 124 that indicates the level of relevance between the content item 116 and the summarization 112. Specifically, the binary content score 120 may include classifying the content item 116 into one of two distinct classes, such as a first class 122A and/or a second class 122B. The first class 122A may correspond to a determination that the content item 116 is relevant to the summarization 112. This may mean that the binary content score 120 effectively embodies the message, style, or substance of the original web resource. In contrast, second class 122B may be associated with content that is deemed irrelevant, meaning the item either misrepresents or fails to adequately capture the intent or theme of the web resource.

The LLM 124 may perform a comparative analysis between the summarization 112 and the content item 116 by interpreting both data elements within a shared semantic framework. The LLM 124 may receive an embedding-based representation of the summarization and content item 116 as inputs. In instances where the content item 116 is multimodal, the system may convert it into a caption or descriptive embedding using auxiliary models prior to ingestion by the LLM 124.

Once both inputs are ingested, the LLM 124 may evaluate whether the content item 116 reflects the themes, tone, concepts, or factual elements expressed in the summarization 112. This comparison may involve aligning concepts from the summarization 112 with elements inferred from the content item 116. The LLM 124 may use attention mechanisms or internal embedding comparisons to assess whether important entities, actions, or attributes present in the summarization are either visually depicted or implied within the content item.

Following this comparison, the LLM 124 may classify the content item 116 into one of two binary classes: the first class 122A (relevant) or the second class 122B (irrelevant). If the content item 116 is found to meaningfully correspond to the summarization 112 it is assigned to the first class 122A. Conversely, if the LLM 124 determines that the content item 116 does not reflect or is incongruent with the summarization 112 it classifies the content as part of the second class 122B. This output indicates that the content item lacks sufficient relevance to the web resource's intended message or identity and may be flagged for exclusion or revision.

The LLM 124, as described herein, is a machine learning-based natural language processing model configured to evaluate the semantic relationship between a summarization 112 of a web resource and a corresponding content item 116. In some embodiments, LLM 124 may be implemented as a lightweight large language model or, alternatively, a small language model (SLM). Lightweight LLMs are scaled-down versions of traditional LLMs, designed to retain core language understanding and generation capabilities while significantly reducing computational and memory demands. These models typically feature fewer transformer layers, reduced hidden dimensions, and a smaller parameter count, making them more efficient for specific tasks like summarization and classification without sacrificing core performance.

SLMs may utilize architectural optimizations like low-rank adaptation, pruning, or quantization to minimize memory footprint and improve inference speed. While SLMs have more limited generalization capacity compared to larger models, they can be highly effective for well-defined, binary, or rule-based tasks, such as content classification.

The LLM 124 may be composed of multiple transformer-based layers, organized in an encoder-decoder or decoder-only architecture, depending on the implementation. For content classification, a decoder-only architecture may be preferred for its ability to generate autoregressive outputs based on initial prompts, using token embeddings, positional encodings, and feed-forward networks to transform raw input into structured semantic representations.

With continued reference to FIG. 1, the operations may include receiving, by the computing system, a training set comprised of exemplary content items correlated to at least one class 122A-B associated with the binary content score 120. The training set may include a plurality of data samples, where each sample includes an exemplary content item, an exemplary summarization of a web resource, and a label indicating the relevance of the content item 116 to the summarization 112. Each label may correspond to a binary content score class 122A-B, including a first class 122A representing “relevant” and a second class 122B representing “irrelevant.” The training set may be structured to enable supervised learning, wherein the LLM 124 may be iteratively optimized to predict the correct binary class based on the input data.

The training set may be generated through a human-in-the-loop process, wherein human raters evaluate exemplary content items for their relevance to a given summarization of a web resource 104. These exemplary content items may include images, text, or other multimedia assets intended to represent aspects of an entity or service described in the web resource 104. Human raters may be presented with a summarization 112 and an associated content item 116 and are tasked with determining whether the content item 116 is relevant to the information in the summarization 112. The raters assign a binary content score class 122A-B to each of the exemplary content items based on predetermined criteria.

Once a sufficient number of exemplary content items have been evaluated and labeled by human raters, the data may undergo a transformation and validation process to convert it into the training set. This may involve formatting the input data into a standardized structure, including tokenizing text, encoding images, and pairing each exemplary content item with its corresponding summarization 112 and relevance label. Additional metadata, such as performance metrics, may also be included to enhance the utility of the dataset. In some embodiments, a quality control step is introduced, whereby content items with ambiguous or conflicting labels are either excluded or resolved through consensus review.

In some embodiments, the training data for fine-tuning the LLM 124 may include performance metrics such as negative rejection rate, positive acceptance rate, and approval rate to guide model refinement and alignment with the evaluative standards expressed within the training data. The negative rejection rate may reflect the proportion of irrelevant content correctly filtered out. The positive acceptance rate measures the proportion of relevant content accurately identified. The approval rate may simulate human evaluations.

With continued reference to FIG. 1, the operations may include fine-tuning, by the computing system, the LLM 124 using the training set. The fine-tuning process may include exposing the LLM 124 to examples from the training set during a supervised learning phase. Each training instance may include a summarization 112 derived from a web resource and a corresponding exemplary content item, along with one or more binary labels that reflect the performance metrics. Through backpropagation and gradient descent optimization, the LLM 124 may update its internal weights and parameters to minimize the loss associated with incorrect predictions.

In some embodiments, fine-tuning the LLM 124 may include optimizing a set of parameters of the model based, at least in part, on one or more performance metrics. During the fine-tuning process, the training algorithm may continuously evaluate the LLM's 124 performance using these performance metrics to assess convergence and guide training adjustments. If, for instance, the negative rejection rate begins to decline or the approval rate fails to improve beyond a threshold, the system may modify training parameters such as the learning rate, training duration, or sampling techniques.

With continued reference to FIG. 1, fine-tuning the LLM 124 may involve applying a low-rank adaptation (LoRA) technique, which selectively adjusts a subset of model parameters by introducing trainable low-rank matrices into specific layers, such as attention or feedforward layers. This approach reduces the number of parameters that must be updated, significantly lowering computational and memory costs while preserving the core knowledge of the pre-trained model.

Additionally, fine-tuning may include terminating the process based on early stopping criteria, such as validation loss, classification accuracy, or approval rate, to prevent overfitting and unnecessary computation. These criteria can be defined in terms of performance metrics on a validation set, ensuring the model retains generalization while adapting to content relevance classification tasks.

In some embodiments, the output of the LLM 124 may be utilized to fine-tune the second machine-learning model 118. Specifically, the binary content score 120 can serve as a supervisory signal for refining the second machine-learning model 118. This feedback loop allows the system to iteratively improve the quality and contextual alignment of the content items 116 generated by the second machine-learning model 118.

The fine-tuning process may involve labeling previously generated content items 116 with binary content scores produced by the LLM 124. These labels may then be used as additional training data for the second machine-learning model 118, enabling it to better learn the features and patterns associated with content relevance. Over time, this approach reinforces the model's ability to produce content items 116 that are more closely aligned with the summarization 112 and, by extension, the underlying intent and context of the web resource 104.

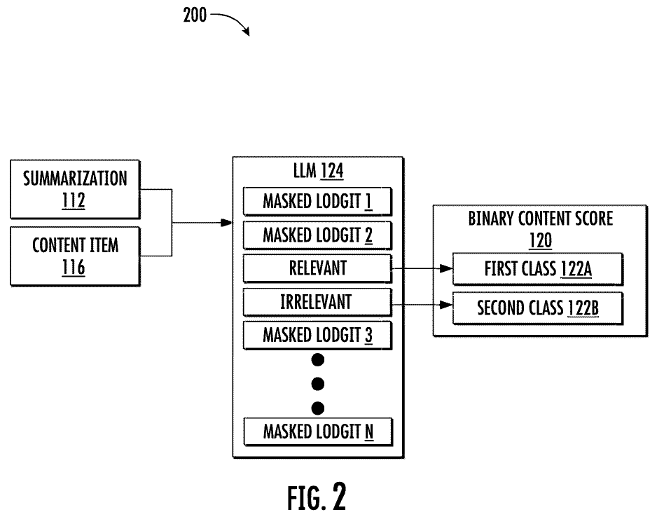

Referring now to FIG. 2, an exemplary embodiment of a logit masking technique for the LLM 124. The LLM 124 may deploy a logit masking technique 200 to generate the binary content score 120. Logit masking is a method for constraining the output space of a large language model (LLM) by explicitly suppressing the probability distribution over undesired output tokens. During inference, logit masking is used to modify the model's logits to restrict its outputs to a predefined subset of permissible tokens. This may be achieved by assigning extremely low scores (e.g., large negative values) to the logits of disallowed tokens, effectively eliminating their chances of being selected during decoding.

The logit masking technique 200 may be used to limit the LLM's output space to just two predefined classes: a first class 122A (e.g., “relevant”) and a second class 122B (e.g., “irrelevant”). This simplifies the LLM's 124 task by eliminating the need to generate full-text responses or navigate a wide vocabulary. Instead, the model evaluates only the relative probabilities of two possible outputs, dramatically reducing the complexity of the decoding process. This approach not only reduces computational costs but also increases the model's reliability in high-throughput environments. Additionally, this approach can significantly reduce the risk of hallucinations in embodiments where both content item 118 generation and content classification rely on the same summarization 112.

Additionally, this limitation prevents the LLM 124 from performing full generative decoding or multi-token sampling, reducing the decision process to a simple comparison of two logits at the first token position. This allows for a single forward pass to yield the final classification, bypassing the need for costly operations like beam search or temperature scaling typically required for full-sequence generation.

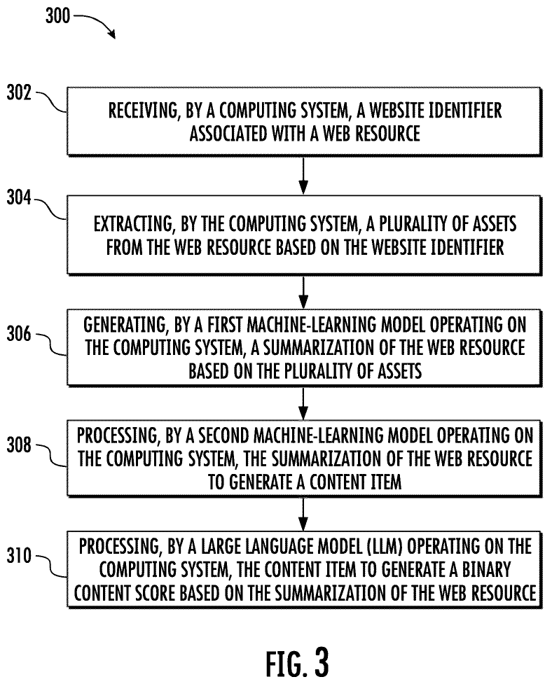

Referring now to FIG. 3, a flow diagram of an exemplary method for fine-tuning a generative model for detecting the relevance of content items in accordance with embodiments of the present disclosure is illustrated.

At operation 302, the method includes receiving, by a computing system, a website identifier associated with a web resource.

At operation 304, the method includes extracting, by the computing system, a plurality of assets from the web resource based on the website identifier. These assets may include textual, visual, and/or metadata components associated with the web resource.

At operation 306, the method includes generating, by a first machine-learning model operating on the computing system, a summarization of the web resource based on the plurality of assets. In some embodiments, the computing system may also receive target data related to the web resource and generate a smart prompt based on the target data and the extracted assets. The smart prompt may be used as contextual input to the first machine-learning model. In certain examples, the smart prompt may comprise a single-shot prompt or a few-shot prompt for providing exemplars to guide the summarization output.

At operation 308, the method includes processing, by a second machine-learning model operating on the computing system, the summarization of the web resource to generate a content item. In some embodiments, the second machine-learning model may include a text-to-image generation model.

At operation 310, the method includes processing, by a large language model (LLM) operating on the computing system, the content item to generate a binary content score based on the summarization of the web resource. In some implementations, the LLM utilizes a logit masking technique to constrain its output space to a predefined set of tokens representing binary classes (e.g., “relevant” or “not relevant”). The binary score may serve as an indication of the relevance or alignment of the content item with respect to the original web resource.

In certain embodiments, the method further includes fine-tuning the LLM using a training set composed of exemplary content items that are correlated with known binary classes. The training set may also include one or more performance metrics for each example, which may be used to optimize model parameters during fine-tuning. To improve efficiency and generalization, the fine-tuning process may incorporate a low-rank adaptation (LoRA) technique to selectively adjust a subset of the model's parameters. Additionally, fine-tuning may be terminated based on one or more early stopping criteria, such as validation loss plateau or convergence thresholds.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A computer-implemented method, comprising:
receiving, by a computing system, a website identifier associated with a web resource;
extracting, by the computing system, a plurality of assets from the web resource based on the website identifier;
generating, by a first machine-learning model operating on the computing system, a summarization of the web resource based on the plurality of assets;
processing, by a second machine-learning model operating on the computing system, the summarization of the web resource to generate a content item; and
processing, by a large language model (LLM) operating on the computing system, the content item to generate a binary content score based on the summarization of the web resource.

2. The computer-implemented method of claim 1, wherein the LLM deploys a logit masking technique to generate the binary content score.

3. The computer-implemented method of claim 2, wherein the logit masking technique comprises restricting an output space of the LLM to a predefined set of tokens corresponding to binary classes of the binary content score.

4. The computer-implemented method of claim 1, wherein the method further comprises:
receiving, by the computing system, target data associated with the web resource;
generating, by the computing system, a smart prompt based on the target data and the plurality of assets; and
generating, by the first machine-learning model, the summarization of the web resource based on the plurality of assets and the smart prompt.

5. The computer-implemented method of claim 4, wherein the smart prompt comprises a few-shot prompt.

6. The computer-implemented method of claim 1, wherein the method further comprises:
receiving, by the computing system, a training set comprised of exemplary content items correlated to at least one class associated with the binary content score; and
fine-tuning, by the computing system, the LLM using the training set.

7. The computer-implemented method of claim 6, wherein:
the training set further comprises one or more performance metrics associated with each of the exemplary content items, wherein the one or more performance metrics are indicative of the exemplary content items' relevance to the binary class; and
fine-tuning the LLM comprises optimizing a set of parameters of the LLM based at least in part on the performance metrics.

8. The computer-implemented method of claim 6, wherein fine-tuning the LLM further comprises applying a low-rank adaptation (LoRA) technique to selectively adjust a subset of parameters of the LLM.

9. The computer-implemented method of claim 6, wherein fine-tuning the LLM further comprises terminating fine-tuning of the LLM based on one or more early stopping criteria.

10. The computer-implemented method of claim 1, wherein the second machine-learning model comprises a text to image generation model.

11. A computing system, comprising:
one or more processors; and
one or more transitory or non-transitory computer-readable media storing instructions that are executable to cause the one or more processors to perform operations, the operations comprising:
receiving a website identifier associated with a web resource;
extracting a plurality of assets from the web resource based on the website identifier;
generating, by a first machine-learning model, a summarization of the web resource based on the plurality of assets;
processing, by a second machine-learning model, the summarization of the web resource to generate a content item; and
processing, by a large language model (LLM), the content item to generate a binary content score based on the summarization of the web resource, wherein the LLM deploys a logit masking technique to generate the binary content score, wherein the logit masking technique comprises restricting an output space of the LLM to a predefined set of tokens corresponding to binary classes of the binary content score.

12. The computing system of claim 11, wherein the operations further comprise:
receiving target data associated with the web resource;
generating a smart prompt based on the target data and the plurality of assets; and
generating, by the first machine-learning model, the summarization of the web resource based on the plurality of assets and the smart prompt.

13. The computing system of claim 12, wherein the smart prompt comprises a few-shot prompt.

14. The computing system of claim 11, wherein the operations further comprise:
receiving, by the computing system, a training set comprised of exemplary content items correlated to at least one class associated with the binary content score; and
fine-tuning, by the computing system, the LLM using the training set.

15. The computing system of claim 14, wherein:
the training set further comprises one or more performance metrics associated with each of the exemplary content items, wherein the one or more performance metrics are indicative of the exemplary content items' relevance to the binary class; and
fine-tuning the LLM comprises optimizing a set of parameters of the LLM based at least in part on the performance metrics.

16. The computing system of claim 14, wherein fine-tuning the LLM further comprises applying a low-rank adaptation (LoRA) technique to selectively adjust a subset of parameters of the LLM.

17. The computing system of claim 14, wherein fine-tuning the LLM further comprises terminating fine-tuning of the LLM based on one or more early stopping criteria.

18. The system of claim 11, wherein the second machine-learning model comprises a text to image generation model.

19. A computer-implemented method, comprising:
receiving, by a computing system, a training set comprised of exemplary content items correlated to at least one class associated with a binary content score, wherein the training set further comprises one or more performance metrics associated with each of the exemplary content items, wherein the one or more performance metrics are indicative of the exemplary content items'relevance to the binary class;
fine-tuning, by the computing system, a Large Language Model (LLM) using the training set, wherein fine-tuning the LLM comprises optimizing a set of parameters of the LLM based at least in part on the performance metrics; and
restricting, by the computing system, an output space of the LLM to a predefined set of tokens corresponding to binary classes of the binary content score.

20. The computer-implemented method of claim 19, wherein the LLM comprises a light-weight large language model.
